(19) United States
(12) Patent Application Publication
(10) Pub. No.: US 2025/0165522 A1
(43) Pub. Date: May 22, 2025

(54) Perform Image Simularity Search with one or More Generated Images

(71) Applicant: Intel Corporation, Santa Clara, CA (US)

(72) Inventors: Jainaveen Sundaram PRIYA, Hillsboro, OR (US); Ravishankar IYER, Portland, OR (US)

(73) Assignee: Intel Corporation, Santa Clara, CA (US)

(21) Appl. No.: 18/428,494

(22) Filed: Jan. 31, 2024

(51) Int. Cl. G06F 16/532; G06F 16/56; G06T 5/60; G06T 7/194; G06T 15/20

(52) U.S. Cl. CPC G06F 16/532; G06F 16/56; G06T 5/60; G06T 7/194; G06T 15/205

(57) ABSTRACT

Image similarity search results can be improved by augmenting a query image with images that are generated based on the query image. The generated images can have different camera poses, different lighting conditions, etc. The generated images can be generated using machine learning models. Using an ensemble of images having the query image and the generated images when searching a library of candidate images can improve performance of image similarity search. Producing effective generated images is not trivial. Also, an image similarity search algorithm may be modified to identify and rank top matching images that are most similar to the ensemble of images.

### BACKGROUND

Image similarity search (ISS) is an algorithm that can find images that are similar to a given image. ISS can be used in reverse image search engines. A user can use a digital camera to capture an image of a product that the user is interested in purchasing and submit the image to a reverse image search engine. The reverse image search engine can identify if the image is similar to other images in a data store. Specifically, ISS can analyze the image and compare the image to the other images. The reverse image search engine can return an image that is similar to the original image (e.g., a product image on a shopping website) and information associated with the returned image (e.g., product name and price).

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates using generated images in a similarity search, according to some embodiments of the disclosure.

FIG. 2 illustrates providing information to a similarity search engine and receiving information from the similarity search engine, according to some embodiments of the disclosure.

FIG. 3 illustrates extracting information about a query image and one or more exemplary image generators, according to some embodiments of the disclosure.

FIG. 4 illustrates one or more exemplary image generators involving a diffusion model, according to some embodiments of the disclosure.

FIG. 5 illustrates exemplary operations of a similarity search engine, according to some embodiments of the disclosure.

FIG. 6 is a flowchart showing a method that performs image similarity search with one or more generated images, according to some embodiments of the disclosure.

FIG. 7 is a block diagram of an exemplary computing device, according to some embodiments of the disclosure.

### DETAILED DESCRIPTION

### Overview

ISS is a technique that can find images that are similar to a query image. ISS can be used in a variety of applications, such as reverse image search engines, identifying a particular object across a video sequence, tracking a particular object across a video sequence, etc. ISS can implement one or more approaches to finding the images (or matching images) that are similar to the query image. Exemplary approaches may include key point matching, normalized cross-correlation, histogram comparison, embedding/feature vector comparison, N-dimensional nearest neighbors determination, etc.

ISS can find one or more matching candidate images in a library of candidate images that are most similar to the query image. In some embodiments, ISS can implement a searching function that searches through the library of candidate images to determine one or more matching candidate images. The searching function may include determining similarity scores that measures how similar the query image is to different candidate images. ISS can implement a selection function that selects a number of matching candidate images having a sufficiently high similarity score. ISS can implement a ranking function that ranks the matching candidate images based on similarity scores. A system implementing ISS can output the matching candidate images as results to an end user, e.g., in a ranked order starting with the most similar matching candidate image.

In some embodiments, ISS can use a deep learning model to, in an offline process, generate embeddings or feature vectors of candidate images. Candidate images can include images of various objects and/or scenes. Candidate images can include images of a video sequence. The deep learning model may receive an input image, such as a candidate image, and output embeddings or a feature vector for the input image. The embeddings or feature vectors of candidate images may be stored and maintained in a library (or other suitable data storage or database) of candidate feature vectors. ISS can use the deep learning model to, in an online process, generate embeddings or a feature vector of the query image. ISS can compute similarity metrics and compare the feature vector of the query image with feature vectors of the candidate images. ISS can implement a selection function that selects a number of matching candidate feature vectors having sufficiently high similarity metrics or similarity metrics that meet a certain condition. ISS can implement a ranking function that ranks the matching candidate feature vectors based on the similarity metrics. The matching candidate images corresponding to the matching candidate feature vectors can be determined. A system implementing a similarity search algorithm can output the matching candidate images as results to an end user, e.g., in a ranked order starting with the most similar matching candidate image.

One approach to improving ISS is to use a better pre-trained deep learning model to generate embeddings or feature vectors. Another approach to improving ISS is to use a more efficient or faster search algorithm to find matching candidate images or matching candidate feature vectors.

ISS results can be improved by implementing an approach that can complement the two approaches above. A query image can be augmented with images that are generated based on or conditioned on the query image. The generated images can have different camera poses, different lighting conditions, etc. The generated images can be generated using machine learning models, or deep learning models. The generated images can be generated using digital signal processing techniques. The generated images may offer more views or diverse views of content in the query image, which may improve the ability of ISS to find a number of top matching candidate feature vectors or a number of top matching candidate images. Using an ensemble of images having the query image and the generated images when searching a library of candidate images can improve performance metrics of ISS. In some cases, using the ensemble of images can improve efficiency of ISS.

Producing effective generated images to be used as part of the ensemble of images as input to a similarity search engine is not trivial. Generated images can be produced using one or more techniques. Exemplary techniques can include image processing techniques, digital signal processing techniques, deep learning models (e.g., generative machine learning models), etc. One technique may include neural radiance field (NeRF), which includes a full-connected neural network that can generate novel views of a scene (e.g., at novel camera positions). One technique may include a deep learning model that can learn distributions, features, representations, or patterns of the query image (e.g., forming a three-dimensional model of a scene) and use the distributions/representations/patterns to synthesize or generate images. One technique may include a diffusion model. One technique may include a generative adversarial network. One technique may include generating images with varied lighting conditions. One technique may include generating images with varied pixel densities. One or more techniques can be selected based on the query image. The number of generated images to generate and use can impact performance of ISS. The number can be determined based on the query image. Information about the query image can be used as a signal to control the algorithm implemented in the similarity search engine. Feedback information from the similarity search engine can impact generation of further generated images.

Also, ISS algorithm in the similarity search engine may be modified to identify and rank top matching images that are most similar to the ensemble of images. In particular, an ensemble similarity metric can be computed for various candidate feature vectors that measures similarity to the ensemble of images having the query image and the generated images. The ensemble similarity metric calculation can be based on information about the query image. The ensemble similarity metric calculation can be based on information from one or more image generators generating the generated images. The ranking of a number of top matching candidate feature vectors can be based on information about the query image. The ranking of the number of top matching candidate feature vectors can be based on information from one or more image generators generating the generated images. The similarity search engine can assess the quality of the number of top matching candidate feature vectors based on the ensemble similarity metrics of the top matching candidate feature vectors.

Improved ISS can be applied in applications that involve reverse image searching, such as object identification in images and images in video sequences, candidate image retrieval, query by image content, etc. One exemplary application is edge video analytics, which may include detection, classification, identification, counting, and tracking on input video sequences. Improved ISS can boost object search capabilities within video sequences. Another exemplary application is smart retail, which may include inventory tracking and management in a frictionless-retail space. Improved ISS can ensure object search capabilities are more robust or agnostic to how a customer holds a product or object.

### Using Generated Images in Image Similarity Search

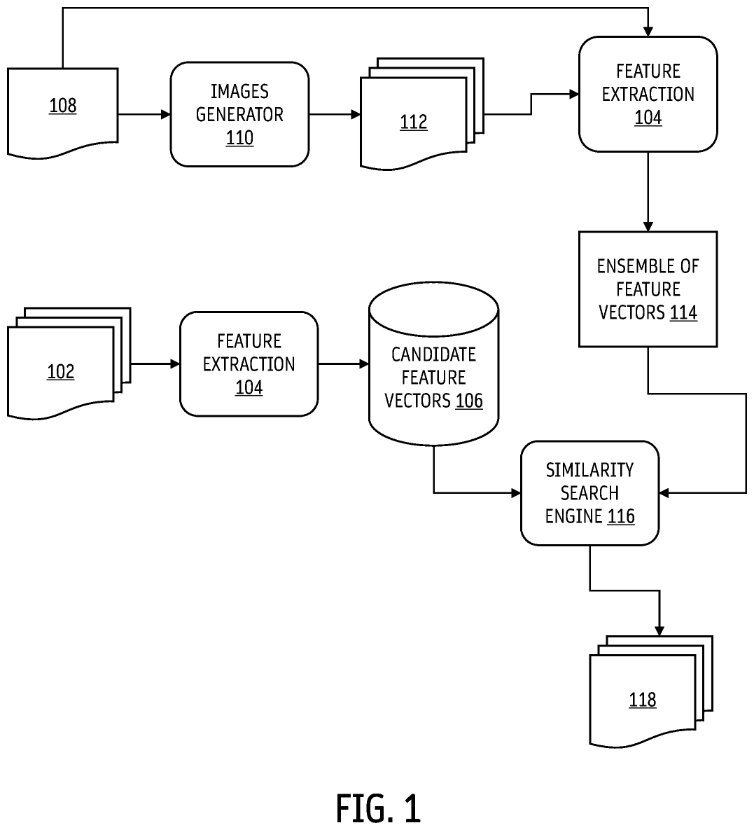

FIG. 1 illustrates using generated images in a similarity search, according to some embodiments of the disclosure. A similarity search, or similarity search pipeline may receive one or more query images 108 and can find one or more top matching candidate images that are (most) similar to the one or more query images 108. Besides using one or more query images 108, the similarity search generates one or more generated images 112 to augment one or more query images 108. The one or more query images 108 and one or more generated images 112 may form an ensemble of query images, which can be used by a similarity search engine 116 to find the one or more top matching candidate images.

Candidate images 102 may include images of various objects or scenes. Candidate images 102 may include images in a video sequence (or video stream). Candidate images 102 may include target images for the similarity search.

One or more query images 108 may include one or more images of one or more objects or a scene of interest. A user may use an image capturing device, e.g., a digital camera, to capture one or more images of the one or more objects or the scene of interest. A user may hold the one or more objects within a field of view of the image capturing device to obtain the one or more query images 108. The one or more query images 108 may include images of a (short) video sequence. One or more query images 108 may include an indication of content to be retrieved.

Candidate images 102 (e.g., a library of candidate images) may be provided to feature extraction 104. Feature extraction 104 may transform candidate images 102 into a format that is suitable for finding matches efficiently and effectively. In some embodiments, feature extraction 104 may transform candidate images 102 into corresponding embeddings or candidate feature vectors 106. Feature extraction 104 may output candidate feature vectors 106. Feature extraction 104 may receive an input image, such as a candidate image in candidate images 102, and output embeddings or a feature vector for the input image. The embeddings or the feature vector may be obtained at the output of the fully-connected layer(s) of a deep learning model. Candidate images 102 can be transformed by feature extraction 104 into embeddings or candidate feature vectors 106. Candidate feature vectors 106 may be stored and maintained in a library, a database, or some suitable data store.

In some embodiments, feature extraction 104 may include digital signal processing that can extract features or information from individual candidate images 102. In some embodiments, feature extraction 104 may include a (pre-trained) deep learning model. The deep learning model can include computer-vision related neural network model having many (e.g., hundreds to thousands) convolutional layers that form a convolutional neural network. A convolutional neural network may include convolutional layers that apply a set of filters to the input image to extract features such as edges, corners, and shapes. A filter may include a small matrix of weights that slides over the input image and performs a dot product at each location. The output of the convolutional layers can include a feature map, which may highlight a presence of a particular feature in the image. In some cases, the convolutional neural network may include one or more rectified linear units that can includes one or more activation functions that introduce non-linearity into the convolutional neural network. In some cases, the convolutional neural network may include one or more pooling layers that take the maximum or average value of a small region of a feature map. In some cases, the convolutional neural network may include one or more fully-connected layers that take the output of pooling layers and flatten the output into embeddings or a feature vector. When used for classification, the convolutional neural network may include a last layer or classification layer that processes the embeddings or the feature vector and generates one or more final outputs. Examples of a suitable deep learning model that may be used in feature extraction 104 may include AlexNet, GoogleNet, Xception, Residual Neural Network (ResNet), ResNext-50, and Visual Geometry Group Very Deep Convolutional Networks (VGGNet). The last layer or classification layer of the deep learning model may be removed or omitted to generate embeddings or feature vectors. Embeddings or feature vectors may be obtained at the output(s) of the penultimate layer of the deep learning model. A feature vector may have a size 1×N, e.g., having N feature embeddings.

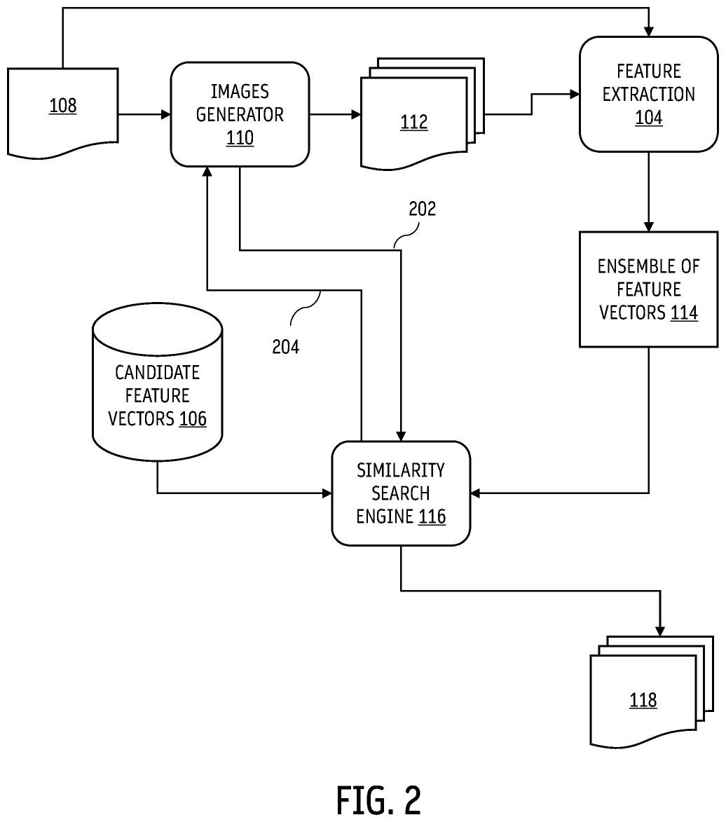

The similarity search may include images generator 110 to generate one or more generated images 112 based on one or more query images 108. Images generator 110 may include one or more image generators. Details about images generator 110 are described with FIGS. 2-4. One or more generated images 112 may complement one or more query images 108 to form an ensemble of query images. The ensemble of query images may improve performance of the similarity search.

Feature extraction 104 may receive one or more query images 108 and transform one or more query images 108 into a format that is suitable for finding matches efficiently and effectively. Feature extraction 104 may generate one or more first feature vectors based on one or more query images 108. Feature extraction 104 may generate a corresponding first feature vector for each one of one or more query images 108. Feature extraction 104 may receive one or more generated images 112 and transform one or more generated images 112 into a format that is suitable for finding matches efficiently and effectively. Feature extraction 104 may generate one or more second feature vectors based on one or more generated images 112. Feature extraction 104 may generate a corresponding second feature vector for each one of one or more query images 108. The one or more first feature vectors and the one or more second feature vectors may form ensemble of feature vectors 114.

One or more query images 108 may include I number of images. Feature extraction 104 may generate I number of feature vectors. One or more generated images 112 may include Q number of images. Feature extraction 104 may generate Q number of feature vectors. Ensemble of feature vectors 114 may include Q+I feature vectors. Ensemble of feature vectors 114 may include a Nx(Q+I) matrix of feature embeddings.

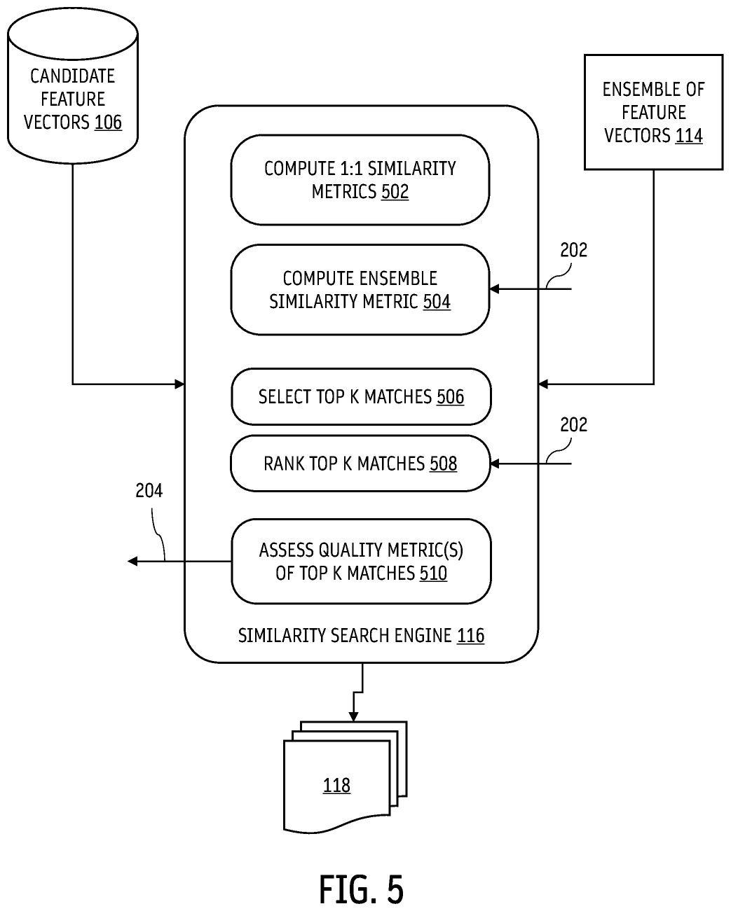

Similarity search engine 116 can receive candidate feature vectors 106 and ensemble of feature vectors 114. Similarity search engine 116 can compare ensemble feature vectors 114 against candidate feature vectors 106 to search for or identify matching candidate feature vectors in the library of candidate feature vectors 106. Similarity search engine 116 may search for one or more matching feature vectors to the ensemble of feature vectors 114 (having the one or more first feature vectors and the one or more second feature vectors) in the library of candidate feature vectors 106 generated from candidate images 102. The searching process may include computing similarity metrics or ensemble similarity metrics that measure distances and/or similarity between a candidate feature vector and one or more feature vectors in the ensemble of feature vectors 114. Similarity search engine 116 can output one or more top matching feature vectors 118 based on the one or more matching feature vectors, e.g., based on the computed similarity metrics or computed ensemble similarity metrics. Similarity search engine 116 can rank one or more top matching feature vectors 118 based on the computed similarity metrics or computed ensemble similarity metrics of one or more top matching feature vectors 118. Similarity search engine 116 may determine corresponding candidate images of one or more top matching feature vectors 118 and output the corresponding candidate images. Similarity search engine 116 may output the corresponding candidate images according to the ranking. Details about similarity search engine 116 are described with FIG. 5.

In some embodiments, similarity search engine 116 may implement an N-dimensional similarity search algorithm (e.g., k-nearest neighbors (kNN), Scikit Nearest Neighbors, Facebook AI Similarity Search (FAISS), etc.) to search through the library of candidate feature vectors 106 to determine one or more matching candidate feature vectors that may be sufficiently similar to one or more feature vectors in the ensemble of feature vectors 114. The N-dimensional similarity search algorithm may include determining similarity metrics that measures how similar or close one or more feature vectors in the ensemble of feature vectors 114 are to different candidate feature vectors in the library of candidate feature vectors 106.

Providing Information to a Similarity Search Engine and Receiving Feedback from the Similarity Search Engine

FIG. 2 illustrates providing information to a similarity search engine and receiving information from the similarity search engine, according to some embodiments of the disclosure.

Images generator 110 may generate information. Path 202 illustrates images generator 110 transmitting the information to similarity search engine 116. Besides generating one or more generated images 112, images generator 110 may extract or determine useful information about one or more query images 108 and/or one or more generated images 112 that may assist similarity search engine 116. In some embodiments, images generator 110 may analyze one or more query images 108 and/or one or more generated images 112 and extract information about one or more query images 108 and/or one or more generated images 112. Images generator 110 may determine and output one or more weights corresponding to the one or more generated images and/or one or more query images 108. The one or more weights can be used by the similarity search engine in the searching of the one or more matching feature vectors. The one or more weights can be used by the similarity search engine in determining and/or ranking of the one or more top matching feature vectors 118. Details regarding how similarity search engine 116 may use the information provided in path 202 are described with FIG. 5.

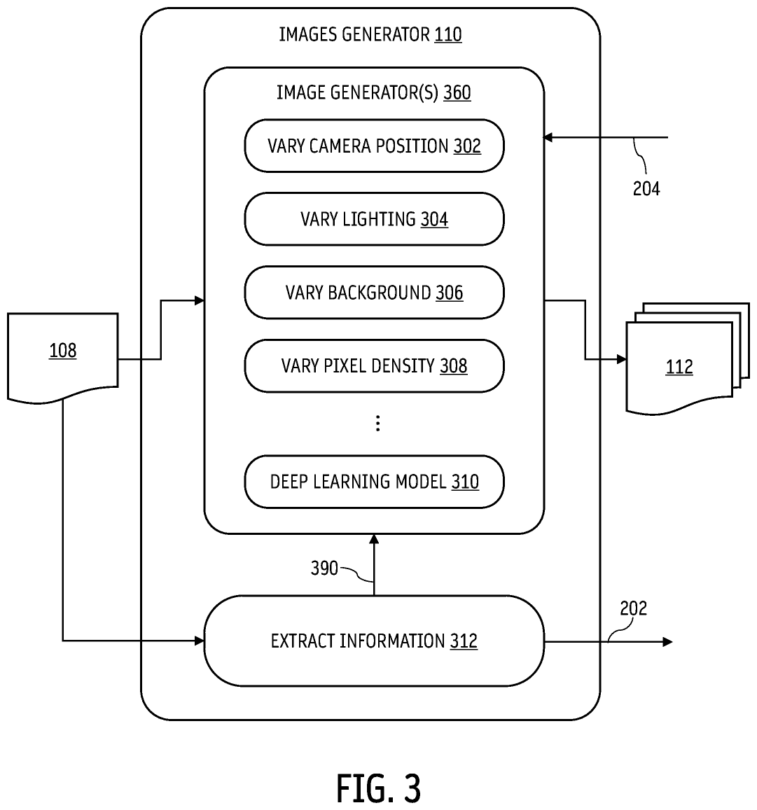

Similarity search engine 116 may generate information. Path 204 illustrates similarity search engine 116 transmitting the information to images generator 110. Besides outputting one or more top matching feature vectors 118, similarity search engine 116 may extract or determine useful information about one or more top matching feature vectors 118 or the similarity search process and provide the useful information as feedback to images generator 110. The feedback provided in path 204 may assist images generator 110. Similarity search engine 116 may analyze the quality of one or more top matching feature vectors 118. Similarity search engine 116 may analyze the efficacy of the searching process. Similarity search engine 116 may determine and output one or more quality metrics associated with the one or more top matching feature vectors 118 as feedback information to images generator 110. Details regarding how images generator 110 may use the information provided in path 204 are described with FIG. 3. Details regarding how similarity search engine 116 may determine the one or more quality metrics are described with FIG. 5.

Using Extracted Information about a Query Image when Generating One or More Images

FIG. 3 illustrates extracting information about a query image and one or more exemplary image generators, according to some embodiments of the disclosure. Images generator 110 may include one or more image generators 360. One or more image generators 360 may include image generators that implement different techniques to generate or create an ensemble of query images. One or more image generators 360 may generate a set of novel generated images, e.g., one or more generated images 112, based on or conditioned on one or more query images 108. One or more generated images 112 may complement one or more query images 108 and improve performance of a similarity search engine. One or more generated images 112 may be generated in a manner that improves performance metrics such as precision, recall, F1 score, mean average precision, normalized discounted cumulative gain, etc. Images generator 110 may use one or more ones of one or more image generators 360 to produce one or more generated images 112. Using a mix or combination of image generators 260 may generate a diverse set of one or more generated images 112 to complement the one or more query images 108.

Generating one or more generated images 112 is not a trivial task. One or more image generators 360 may include one or more of: vary camera position 302, vary lighting 304, vary background 306, vary pixel density 308, and deep learning model 310 that can generate images conditioned on one or more query images 108. A generated image in one or more generated images 112 may be generated using one or more image generators of one or more image generators 360.

Vary camera position 302 may implement NeRF or a similar model to generate one or more generated images 112 that appears to have been captured at different camera positions or viewpoints based on one or more query images 108. Vary camera position 302 may implement a deep, fully-connected, neural network that can predict how a scene or object would appear from a different camera position or viewpoint. Vary camera position 302 may construct a three-dimensional representation of a scene from the one or more query images 108 corresponding to one or more original camera poses. Vary camera position 302 may implement a deep learning model (e.g., a neural network) to form the three-dimensional representation of the scene. Vary camera position 302 may generate, synthesize, and/or render, based on the three-dimensional representation, one or more (novel) views of the scene. A first view of the one or more views has a corresponding camera pose that is different from the one or more original camera poses. The one or more views may be used as one or more generated images 112. Examples of NeRF techniques that may be used in vary camera position 302 include PixelNeRF, MegaNeRF, RegNeRF, LOLNeRF, Neural Sparse Voxel Fields, KiloNeRF, Plenoxels, etc. Vary camera position 302 may generate one or more generated images 112 that shows an object from different camera positions or viewpoints even when one or more query images 108 did not include images that show the object from those camera positions or viewpoints.

Vary lighting 304 may implement digital image processing technique(s) that can generate artificial light sources and apply the artificial light sources to one or more query images 108. Vary lighting 304 may construct a three-dimensional representation of a scene based on one or more query images 108. Vary lighting 304 may generate one or more generated images 112 that have different lighting conditions than the lighting conditions of one or more query images 108. Vary lighting 304 may apply one or more artificial light sources in the three-dimensional representation of the scene. Vary lighting 304 may render, based on the one or more query images 108, one or more augmented images with one or more artificial light sources added to the one or more query images. A first artificial light source can have a (novel or different) directionality and/or an (novel or different) intensity that did not previously exist in one or more query images 108. 304 may render one or more query images 108 using the three-dimensional representation of the scene with the one or more artificial light sources added to it. In some cases, vary lighting 304 may adjust the exposure of one or more query images 108. In some cases, vary lighting 304 may change the white balance of one or more query images 108. In some cases, vary lighting 304 may change or tune other parameters of one or more query images 108. In some cases, vary lighting 304 may adjust a color curve of one or more query images 108. In some cases, vary lighting 304 may adjust color tones of one or more query images 108. In some cases, vary lighting 304 may change or tune other parameters of one or more query images 108. In some cases, vary lighting 304 may modify pixel values in a particular area or region of one or more query images 108 to add one or more artificial light sources to one or more query images 108.

Vary background 306 may implement digital image processing technique(s) and/or one or more deep learning models to identify foreground and/or background of one or more query images 108. Vary background 306 may manipulate a background area or region of at least one or more of one or more query images 108. Vary background 306 may remove a background of at least one or more of one or more query images 108. Vary background 306 may replace a background of at least one or more of the one or more query images with a different background (e.g., a background from a different scene, a different pattern, a different color, etc.). Vary background 306 may blur a background of at least one or more of one or more query images 108. Vary background 306 may inpaint a background of at least one or more of one or more query images 108.

Vary pixel density 308 may implement digital image processing technique(s) and/or one or more deep learning models to change pixel density or resolution of one or more query images 108. Vary pixel density 308 may perform interpolation or upscaling to increase pixel density or resolution of one or more query images 108. Vary pixel density 308 may include a neural network to enhance at least one or more of one or more query images 108. A neural network may include nodes (or neurons) which are connected to each other. The nodes may be organized in layers. The first layer may include an input layer. The last layer may include an output layer. One or more layers inbetween the first layer and the last layer may include hidden layers. One or more input values may be provided as input to node(s) in the input layer. The node(s) in the output layer may generate one or more output values. Nodes in the hidden layers can perform computation on the input(s) to the nodes and passes output(s) to a next layer. Connections between nodes may have weights that may determine the strength of the signal being passed between nodes. Vary pixel density 308 may include a machine learning model or a deep learning model to analyze one or more query images 108 and apply the analysis to clarify and/or sharpen at least one or more of one or more query images 108. Vary pixel density 308 may include a machine learning model or a deep learning model to upscale at least one or more of one or more query images 108 to increase pixel density or resolution of at least one or more of one or more query images 108.

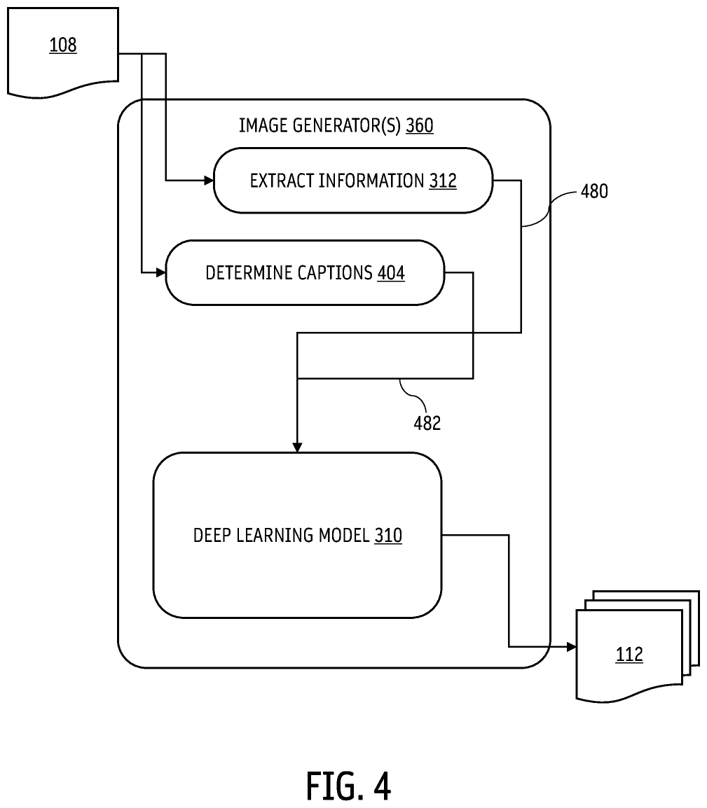

Deep learning model 310 may include one or more machine learning based generative models that may generate one or more generated images 112, e.g., based on or conditioned on one or more query images 108. Deep learning model 310 may include a NeRF-based model. 310 may include a generative adversarial neural network. Deep learning model 310 may include an autoencoder neural network. Deep learning model 310 may include a diffusion model to generate one or more generated images 112. A diffusion model may include a forward process that adds noise to training images, a reverse process that removes the noise to obtain the training images. The diffusion model may include a sampling network (e.g., a deep neural network) that can learn or mirror the reverse process through training. When input noise is provided to the sampling network having the learned reverse process, the input noise can undergo the learned reverse process to generate state-of-the images to be used as one or more generated images 112. The learned reverse process implemented in the sampling network can be conditioned or guided based on information or signals such as text, feature vectors, feature embeddings, audio, semantic map, representations, images, etc., so that the sampling network can generate more specific classes of images to be used as one or more generated images 112. In some cases, extract information 312 may determine information and/or signals from one or more query images 108. The diffusion model may generate one or more generated images 112 conditioned on the information and/or signals. Details relating to conditioning deep learning model 310 are described with FIG. 4.

Not all image generator(s) 360 are made equal. In some cases, depending on characteristics of one or more query images 108, certain ones of one or more image generators 360 may be more suitable than others of one or more image generators 360. Extract information 312 may extract information about one or more query images 108. Extract information 312 may determine and/or select, based on the information, the one or more image generators in one or more image generators 360 to be used to generate the one or more generated images 112. One or more selection signals may be passed from extract information 312 to one or more image generators 360 in path 390.

The number (e.g., Q) of one or more generated images 112 to be generated by one or more image generators 360 may impact efficiency and/or efficacy of the similarity search. Too few generated images may not improve performance of similarity search. Too many generated images may not significantly improve performance of similarity search and increase latency/processing time of similarity search. Extract information 312 may extract information about one or more query images 108. Extract information 312 may determine, based on the information, a number of images (e.g., Q) to generate using the one or more image generators 360. A signal indicating the number of images may be passed from extract information 312 to one or more image generators 360 in path 390.

The number or proportion of images to generate using a particular image generator of one or more image generators 360 relative to a total number of one or more generated images 112 may impact efficiency and/or efficacy of the similarity search. Having more generated images in one or more generated images 112 generated by a particular image generator of one or more image generators 360 may improve performance of similarity search. Extract information 312 may extract information about one or more query images 108. Extract information 312 may determine, based on the information, one or more corresponding numbers of images to generate using the one or more image generators 360. For certain one or more query images 108, increasing a proportion of images to generate using a particular image generator of one or more image generators 360 may improve performance of similarity search. One or more signals indicating one or more corresponding numbers of images to generate using the one or more image generators 360 may be passed from extract information 312 to one or more image generators 360 in path 390.

Extract information 312 may extract information and/or signals using one or more query images 108. The information and/or signals may include captions, text, semantic meaning, intent, contextual information, audio, image, feature embedding, representations, classification, semantic map, etc. The information and/or signals may be used to generate control signals for controlling one or more image generators 360 and dictate how one or more generated images 112 are generated.

The information and/or signals may be used to produce information to be provided to similarity search engine 116. The information and/or signals may be provided to similarity search engine 116 in path 202. The information and/or signals may inform how similarity and/or distance is to be assessed. The information and/or signals may inform how matching feature vectors are to be selected. The information and/or signals may inform how top matching feature vectors are to be ranked. For example, extract information 312 may determine, based on the information, weights. The weights may correspond to the one or more first feature vectors and the one or more second feature vectors in ensemble of feature vectors 114 of FIG. 1, or one or more query images 108 and one or more generated images 112. The weights may correspond to how important or useful certain feature vectors are in ensemble of feature vectors 114 when similarity search engine 116 of FIG. 1 is to perform searching for matching candidate feature vectors, selecting/determining top matching candidate feature vectors, and/or ranking the top matching candidate feature vectors. The weights can be used by the similarity search engine 116 in the searching of the one or more matching feature vectors. The weights can be used by the similarity search engine 116 in the selecting or determining the one or more top matching feature vectors. The weights can be used by the similarity search engine 116 in the ranking of the one or more top matching feature vectors.

Feedback information generated by similarity search engine 116 may be provided to images generator 110 in path 204. The feedback information may be used to control one or more image generators 360 and dictate how one or more generated images 112 are generated. The feedback information may relate to the quality of results from similarity search engine 116.

One or more image generators 360 may receive, from the similarity search engine 116 in path 204, one or more quality metrics associated with the one or more top matching feature vectors 118 of FIG. 1 as feedback information to one or more image generators 360. One or more image generators 360 may select, based on the one or more quality metrics, one or more further image generators to be used in generating one or more further generated images.

One or more image generators 360 may receive, from the similarity search engine 116 in path 204, one or more quality metrics associated with the one or more top matching feature vectors 118 of FIG. 1 as feedback information to one or more image generators 360. One or more image generators 360 may generate one or more further images in response to the one or more quality metrics not meeting one or more conditions (e.g., quality metric(s) not scoring high enough or not meeting one or more thresholds, quality metric(s) not meeting one or more success criterion, quality metric(s) scoring too low or do not meet one or more thresholds, etc.). Feature extraction 104 of FIG. 1 may generate one or more third feature vectors based on the one or more further generated images. Similarity search engine 116 of FIG. 1 may search, for one or more further matching feature vectors to the one or more first feature vectors, the one or more second feature vectors, and the one or more third feature vectors in the library of candidate feature vectors. Similarity search engine 116 of FIG. 1 may search for one or more further matching feature vectors to the one or more first feature vectors, and the one or more third feature vectors in the library of candidate feature vectors (e.g., omitting at least one or more of the second feature vectors). Similarity search engine 116 may output, one or more further top matching feature vectors based on the one or more further matching feature vectors.

In some cases, the feedback information may be used to dictate or determine whether to produce any generated images 112 by one or more image generators 360. In some cases, the feedback information may be used to dictate or determine how many one or more generated images 112 are to be generated by one or more image generators 360. In some cases, the feedback information may be used to dictate or determine which one or more ones of one or more image generators 360 to use to generate one or more generated images 112. In some cases, the feedback information may be used to dictate or determine the number of generated images to produce by a particular one of the one or more image generators 360. A rules engine, a model, a logic tree, a decision tree, a voting scheme, a function, and/or a suitable decision or recommendation engine may be implemented to process the feedback information and determine suitable control signals for one or more image generators 360.

In some cases, no generated images 112 are used and similarity search engine 116 may make a first or initial attempt to find top matching candidate feature vectors that are most similar to one or more query images 108 (only). Similarity search engine 116 may produce the one or more quality metrics as feedback information to one or more image generators 360. One or more image generators 360 may select, based on the one or more quality metrics, one or more image generators to be used in generating one or more generated images 112. One or more image generators 360 may determine, based on the one or more quality metrics, a number of one or more generated images 112 to be generated by one or more image generators 360. One or more image generators 360 may determine, based on the one or more quality metrics, the number of generated images to produce by a particular one of the one or more image generators 360. One or more generated images 112 and one or more query images 108 may be used as an ensemble of query images. Taking the ensemble of query images (e.g., feature vectors generated therefrom), similarity search engine 116 may make a second attempt to find top matching candidate feature vectors that can improve on the one or more quality metrics.

### Conditioning a Diffusion Model to Generate Images Based on the Query Image

FIG. 4 illustrates one or more exemplary image generators involving a diffusion model, according to some embodiments of the disclosure. Deep learning model 310 may include a diffusion model or a suitable generative machine learning model that may generate one or more generated images 112 conditioned on information about one or more query images 108.

In path 480, information and/or signals extracted by extract information 312 may be provided to deep learning model 310 and used as conditioning input to deep learning model 310 (e.g., a diffusion model).

Determine captions 404 may receive one or more query images 108 and determine one or more captions or text about one or more query images 108. Determine captions 404 may implement a machine learning model or a deep learning model that analyzes one or more query images 108 to extract features. Determine captions 404 may implement a natural language processing model (e.g., a recurrent neural network or transformer-based network) and generate/output natural language text that is descriptive of one or more query images 108 based on the extracted features. In path 482, captions or text and/or feature embeddings thereof may be provided deep learning model 310 and used as conditioning input to deep learning model 310 (e.g., a diffusion model).

### Exemplary Similarity Search Engine and its Operations

FIG. 5 illustrates exemplary operations of a similarity search engine 116, according to some embodiments of the disclosure. Similarity search engine 116 may include one or more of: a searching process, a selection process, and a ranking process. Similarity search engine 116 can be implemented to take advantage of information about the ensemble of feature vectors 114, the generated images (e.g., one or more generated images 112 of FIG. 1), and/or the query images (e.g., one or more query images 108 of FIG. 1).

A searching process for one or more matching feature vectors in similarity search engine 116 involves determining similarity and/or distance of a particular candidate feature vector in candidate feature vectors 106 with one or more ones of the ensemble of feature vectors 114. In some cases, the searching process may include a comparison process. In some cases, the searching process may include a matching process. In some cases, the searching process may include assessing similarity and/or distance between a particular candidate feature vector with one or more ones of the ensemble of feature vectors 114. In some cases, the searching process may include strategically and/or iteratively comparing or assessing similarity and/or distance to find candidate feature vectors that may be matches to the one or more ones of the ensemble of feature vectors 114. In some cases, the searching process may include traversing through a network (e.g., a tree, a graph, etc.), or a suitable database, to efficiently find the matches without having to exhaustively compare one or more ones of the ensemble of feature vectors 114 against each one of the candidate feature vectors 106.

The searching process may include compute 1:1 similarity metrics 502. In compute 1:1 similarity metrics 502, similarity search engine 116 may compute similarity metrics. A similarity metric may compare one candidate feature vector in candidate feature vectors 106 with one of the feature vectors in ensemble of feature vectors 114. The similarity metrics may measure similarity between (1) each one of the one or more first feature vectors and the one or more second feature vectors (of ensemble of feature vectors 114), and (2) a first candidate feature vector in the library of candidate feature vectors 106. A similarity metric may measure similarity between (1) a first one of the one or more first feature vectors and the one or more second feature vectors (one of the feature vectors in ensemble of feature vectors 114), and (2) a first candidate feature vector in the library of candidate feature vectors 106. Similarity search engine 116 may determine the one or more matching feature vectors based on the similarity metrics.

The searching process may include compute ensemble similarity metric 504. In compute ensemble similarity metric 504, similarity search engine 116 may compute an ensemble similarity metric. A similarity metric may compare one candidate feature vector in candidate feature vectors 106 with (a plurality of feature vectors in) ensemble of feature vectors 114. An ensemble similarity metric may measure similarity between (1) an ensemble of feature vectors 114 having the one or more first feature vectors, and the one or more second feature vectors, and (1) a first candidate feature vector in the library of candidate feature vectors 106. Similarity search engine 116 may determine the one or more matching feature vectors based on the ensemble similarity metric. An ensemble similarity metric may measure similarity and/or distance of a particular candidate feature vector to (a plurality of feature vectors in) ensemble of feature vectors 114 as a whole. In some cases, one or more 1:1 similarity metrics may be summed to form the ensemble similarity metric. In some cases, one or more 1:1 similarity metrics may be summed using weights corresponding to different feature vectors in ensemble of feature vectors 114 to form the ensemble similarity metric. In some cases, one or more 1:1 similarity metrics may be combined using a combination function (linear or non-linear) to form the ensemble similarity metric. In some cases, additional information and/or signals may be used by the combination function to combine one or more 1:1 similarity metrics. In some cases, one or more 1:1 similarity metrics may be averaged to form the ensemble similarity metric. In some cases, one or more 1:1 similarity metrics may be averaged, with outliers omitted, to form the ensemble similarity metric.

Similarity search engine 116 may receive one or more weights corresponding to one or more of: the one or more of first feature vectors, and the one or more of second feature vectors in ensemble of feature vectors 114. Similarity search engine 116 may compute a weighted sum of similarity metrics. The similarity metrics may measure similarity between (A) each one of the one or more first feature vectors, and the one or more second feature vectors and, (B) a first candidate feature vector in the library of candidate feature vectors 106, using the one or more weights.

Similarity search engine 116 may receive one or more signals corresponding to one or more of: the one or more of first feature vectors, and the one or more of second feature vectors in ensemble of feature vectors 114. The one or more signals may indicate importance of certain feature vectors. Similarity search engine 116 may compute a combined similarity metric using (A) similarity metrics measuring similarity between (i) each one of the one or more first feature vectors and the one or more second feature vectors, and (ii) a first candidate feature vector in the library of candidate feature vectors, (B) a combination function, and (C) the one or more signals.

A selection process may use the similarity and/or distance to select or determine top K number of matching candidate feature vectors. The subsequent selection process may include select top K matches 506. In select top K matches 506, similarity search engine 116 may select the one or more top matching feature vectors having one or more similarity metrics that meet one or more conditions. In select top K matches 506, similarity search engine 116 may select the one or more top matching feature vectors having one or more ensemble similarity metrics that meet one or more conditions. An exemplary condition may include that a matching feature vector is in a group of K number of matching feature vectors having the highest or top similarity metric and/or ensemble similarity metric. Another condition may include that a matching feature vector is in a group of matching feature vectors having the similarity metric and/or ensemble similarity metric in a certain percentile. Another condition may include that a matching feature vector has a similarity metric and/or ensemble similarity metric meeting a threshold.

A ranking process may use the similarity and/or distance to rank or order the top K number of matching candidate feature vectors. The further ranking process may include rank top K matches 508. In top K matches 508, similarity search engine 116 may rank or order the one or more top matching feature vectors based on one or more similarity metrics computed for the one or more top matching feature vectors. In some cases, in top K matches 508, similarity search engine 116 may rank the one or more top matching feature vectors based on one or more ensemble similarity metrics computed for the one or more top matching feature vectors. In some cases, in top K matches 508, similarity search engine 116 may receive one or more weights corresponding to one or more of: the one or more of first feature vectors, and the one or more of second feature vectors (of ensemble of feature vectors 114). In top K matches 508, similarity search engine 116 may rank the one or more top matching feature vectors based on one or more weights. In some cases, in top K matches 508, similarity search engine 116 may receive one or more signals corresponding to one or more of: the one or more of first feature vectors, and the one or more of second feature vectors (of ensemble of feature vectors 114). In top K matches 508, similarity search engine 116 may rank, by the similarity search engine, the one or more top matching feature vectors based on one or more signals.

In some cases, similarity search engine 116 may assess the quality of the top matching feature vectors. Similarity search engine 116 may determine one or more quality metrics associated with the one or more top matching feature vectors as feedback information to the image generator based on whether one or more similarity metrics for the one or more top matching feature vectors meet one or more conditions. 116 may determine one or more quality metrics associated with the one or more top matching feature vectors as feedback information to the image generator based on whether one or more ensemble similarity metrics for the one or more top matching feature vectors meet one or more conditions. An exemplary condition may include whether a sufficient number of top matching feature vectors have similarity metrics and/or ensemble similarity metrics which meet a threshold. Another exemplary condition may include whether an average of similarity metrics and/or ensemble similarity metrics meet a threshold. Another exemplary condition may include whether a sum of similarity metrics and/or ensemble similarity metrics meet a threshold.

An Exemplary Method for Performing Image Similarity Search with One or More Generated Images

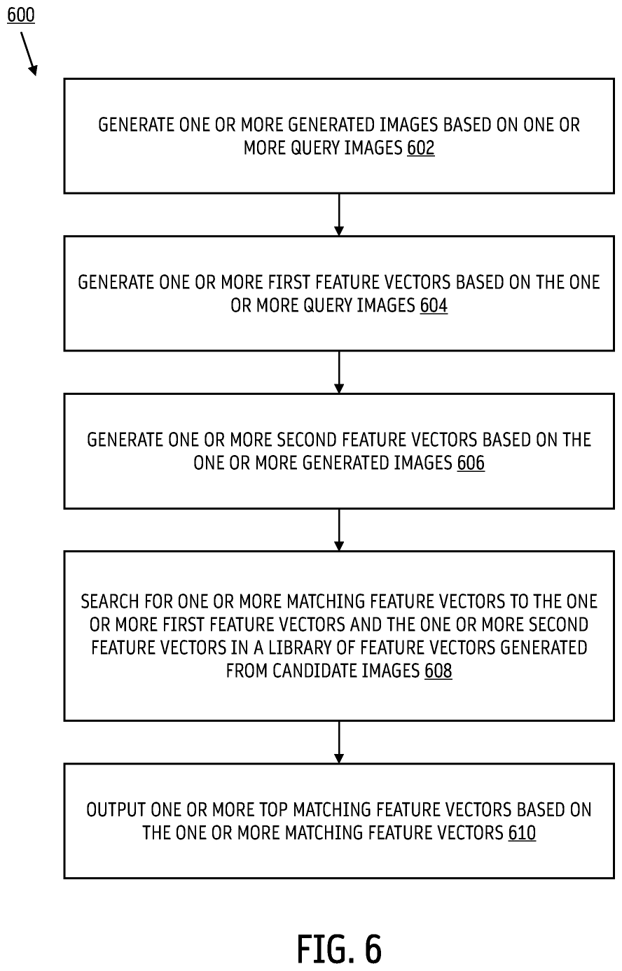

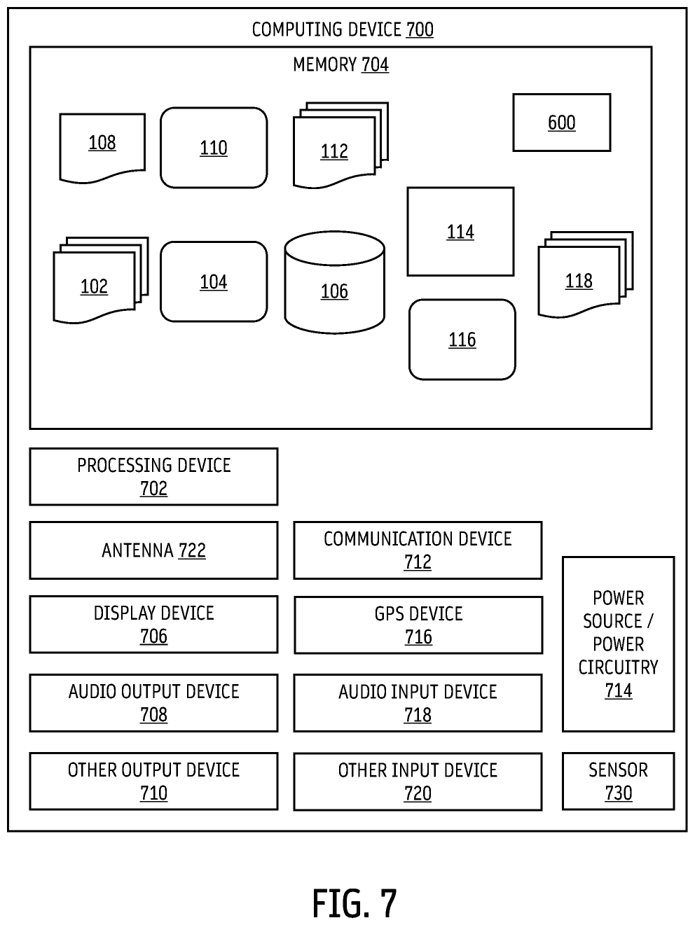

FIG. 6 is a flowchart showing a method 600 that can help make diffusion models more explainable, according to some embodiments of the disclosure. Method 600 can be performed using a computing device, such as computing device 700 in FIG. 7. Method 600 may be performed using one or more parts illustrated FIGS. 1-5. Method 600 may be an exemplary method performed by images generator 110 (e.g., one or more image generators 360) and similarity search engine 116, as illustrated in FIGS. 1-6.

In 602, one or more image generators (e.g., one or more image generators 360) may generate one or more generated images (e.g., one or more generated images 112) based on one or more query images (e.g., one or more query images 108).

In 604, feature extraction part (e.g., feature extraction 104) may generate one or more first feature vectors based on the one or more query images.

In 606, the feature extraction part may generate one or more second feature vectors based on the one or more generated images.

In 608, a similarity search engine (e.g., similarity search engine 116) may search for one or more matching feature vectors to the one or more first feature vectors and the one or more second feature vectors in a library of candidate feature vectors (e.g., candidate feature vectors 106) generated from candidate images.

In 610, the similarity search engine may determine and/or output one or more top matching feature vectors based on the one or more matching feature vectors.

Although the operations of the example method shown in and described with reference to FIG. 6 are illustrated as occurring once each and in a particular order, it will be recognized that the operations may be performed in any suitable order and repeated as desired. Additionally, one or more operations may be performed in parallel. Furthermore, the operations illustrated in FIG. 6 may be combined or may include more or fewer details than described.

### Exemplary Computing Device

FIG. 7 is a block diagram of an apparatus or a system, e.g., an exemplary computing device 700, according to some embodiments of the disclosure. One or more computing devices 700 may be used to implement the functionalities described with the FIGS. and herein. A number of components are illustrated in the FIGS. can be included in the computing device 700, but any one or more of these components may be omitted or duplicated, as suitable for the application. In some embodiments, some or all of the components included in the computing device 700 may be attached to one or more motherboards. In some embodiments, some or all of these components are fabricated onto a single system on a chip (SoC) die. Additionally, in various embodiments, the computing device 700 may not include one or more of the components illustrated in FIG. 7, and the computing device 700 may include interface circuitry for coupling to the one or more components. For example, the computing device 700 may not include a display device 706, and may include display device interface circuitry (e.g., a connector and driver circuitry) to which a display device 706 may be coupled. In another set of examples, the computing device 700 may not include an audio input device 718 or an audio output device 708 and may include audio input or output device interface circuitry (e.g., connectors and supporting circuitry) to which an audio input device 718 or audio output device 708 may be coupled.

The computing device 700 may include a processing device 702 (e.g., one or more processing devices, one or more of the same types of processing device, one or more of different types of processing device). The processing device 702 may include electronic circuitry that process electronic data from data storage elements (e.g., registers, memory, resistors, capacitors, quantum bit cells) to transform that electronic data into other electronic data that may be stored in registers and/or memory. Examples of processing device 702 may include a central processing unit (CPU), a graphical processing unit (GPU), a quantum processor, a machine learning processor, an artificial intelligence processor, a neural network processor, an artificial intelligence accelerator, an application specific integrated circuit (ASIC), an analog signal processor, an analog computer, a microprocessor, a digital signal processor, a field programmable gate array (FPGA), a tensor processing unit (TPU), a data processing unit (DPU), etc.

The computing device 700 may include a memory 704, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 704 includes one or more non-transitory computer-readable storage media. In some embodiments, memory 704 may include memory that shares a die with the processing device 702. In some embodiments, memory 704 includes one or more non-transitory computer-readable media storing instructions executable to perform operations described with the FIGS. and herein, such as the methods and operations illustrated in FIGS. 1-6. Exemplary parts that may be encoded as instructions and stored in memory 704 are depicted. Memory 704 may store instructions that encode one or more exemplary parts. The instructions stored in the one or more non-transitory computer-readable media may be executed by processing device 702. In some embodiments, memory 704 may store data, e.g., data structures, binary data, bits, metadata, files, blobs, etc., as described with the FIGS. and herein. Exemplary data that may be stored in memory 704 are depicted. Memory 704 may store one or more data as depicted.

In some embodiments, memory 704 may store one or more machine learning models (and or parts thereof). Memory 704 may store training data for training (trained) feature extraction 104. Memory 704 may store instructions that perform operations associated with training feature extraction 104. Memory 704 may store training data for training (trained) a component in images generator 110. Memory 704 may store instructions that perform operations associated with training a component in images generator 110. Memory 704 may store input data, output data, intermediate outputs, intermediate inputs of one or more machine learning models. Memory 704 may store instructions to perform one or more operations of the one or more machine learning model. Memory 704 may store one or more parameters used by the one or more machine learning models. Memory 704 may store information that encodes how processing units of the machine learning model are connected with each other. Examples of machine learning models or parts of a machine learning model may include, e.g., machine learning model(s) in images generator 110, and machine learning model(s) in feature extraction 104, etc.

Memory 704 may store instructions that perform operations associated with images generator 110. Memory 704 may store instructions that perform operations associated with feature extraction 104. Memory 704 may store instructions that perform operations associated with similarity search engine 116.

Memory 704 may store one or more query images 108. Memory 704 may store one or more generated images 112. Memory 704 may store one or more feature vectors generated from the one or more query images 108. Memory 704 may store one or more feature vectors generated from the one or more generated images 112. 704. May store ensemble of feature vectors 114. Memory 704 may store candidate images 102. Memory 704 may store candidate feature vectors 106. Memory 704 may store matching candidate feature vectors. Memory 704 may store one or more top matching feature vectors 118. Memory 704 may store one or more candidate images that correspond to the one or more top matching feature vectors 118.

In some embodiments, the computing device 700 may include a communication device 712 (e.g., one or more communication devices). For example, the communication device 712 may be configured for managing wired and/or wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 712 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 712 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 712 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 712 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 712 may operate in accordance with other wireless protocols in other embodiments. The computing device 700 may include an antenna 722 to facilitate wireless communications and/or to receive other wireless communications (such as radio frequency transmissions). The computing device 700 may include receiver circuits and/or transmitter circuits. In some embodiments, the communication device 712 may manage wired communications, such as electrical, optical, or any other suitable communication protocols (e.g., the Ethernet). As noted above, the communication device 712 may include multiple communication chips. For instance, a first communication device 712 may be dedicated to shorter-range wireless communications such as Wi-Fi or Bluetooth, and a second communication device 712 may be dedicated to longer-range wireless communications such as global positioning system (GPS), EDGE, GPRS, CDMA, WiMAX, LTE, EV-DO, or others. In some embodiments, a first communication device 712 may be dedicated to wireless communications, and a second communication device 712 may be dedicated to wired communications.

The computing device 700 may include power source/power circuitry 714. The power source/power circuitry 714 may include one or more energy storage devices (e.g., batteries or capacitors) and/or circuitry for coupling components of the computing device 700 to an energy source separate from the computing device 700 (e.g., DC power, AC power, etc.).

The computing device 700 may include a display device 706 (or corresponding interface circuitry, as discussed above). The display device 706 may include any visual indicators, such as a heads-up display, a computer monitor, a projector, a touchscreen display, a liquid crystal display (LCD), a light-emitting diode display, or a flat panel display, for example.

The computing device 700 may include an audio output device 708 (or corresponding interface circuitry, as discussed above). The audio output device 708 may include any device that generates an audible indicator, such as speakers, headsets, or earbuds, for example.

The computing device 700 may include an audio input device 718 (or corresponding interface circuitry, as discussed above). The audio input device 718 may include any device that generates a signal representative of a sound, such as microphones, microphone arrays, or digital instruments (e.g., instruments having a musical instrument digital interface (MIDI) output).

The computing device 700 may include a GPS device 716 (or corresponding interface circuitry, as discussed above). The GPS device 716 may be in communication with a satellite-based system and may receive a location of the computing device 700, as known in the art.

The computing device 700 may include a sensor 730 (or one or more sensors). The computing device 700 may include corresponding interface circuitry, as discussed above). Sensor 730 may sense physical phenomenon and translate the physical phenomenon into electrical signals that can be processed by, e.g., processing device 702. Examples of sensor 730 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 700 may include another output device 710 (or corresponding interface circuitry, as discussed above). Examples of the other output device 710 may include an audio codec, a video codec, a printer, a wired or wireless transmitter for providing information to other devices, haptic output device, gas output device, vibrational output device, lighting output device, home automation controller, or an additional storage device.

The computing device 700 may include another input device 720 (or corresponding interface circuitry, as discussed above). Examples of the other input device 720 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 700 may have any desired form factor, such as a handheld or mobile computer system (e.g., a cell phone, a smart phone, a mobile internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some embodiments, the computing device 700 may be any other electronic device that processes data.

### Select Examples

Example 1 provides a method comprising: generating, by one or more image generators, one or more generated images based on one or more query images; generating one or more first feature vectors based on the one or more query images; generating one or more second feature vectors based on the one or more generated images; searching, by a similarity search engine, for one or more matching feature vectors to the one or more first feature vectors and the one or more second feature vectors in a library of candidate feature vectors generated from candidate images; and outputting, by the similarity search engine, one or more top matching feature vectors based on the one or more matching feature vectors.

Example 2 provides the method of example 1, further including outputting, by the one or more image generators, one or more weights corresponding to the one or more generated images, where the one or more weights are used by the similarity search engine in the searching of the one or more matching feature vectors.

Example 3 provides the method of example 1 or 2, further including outputting, by the one or more image generators, one or more weights corresponding to the one or more generated images, where the one or more weights are used by the similarity search engine in determining the one or more top matching feature vectors.

Example 4 provides the method of any one of examples 1-3, further including outputting, by the similarity search engine, one or more quality metrics associated with the one or more top matching feature vectors as feedback information to the one or more image generators.

Example 5 provides the method of any one of examples 1-4, where generating the one or more generated images includes constructing a three-dimensional representation of a scene from the one or more query images corresponding to one or more original camera poses; and generating, based on the three-dimensional representation, one or more views of the scene, where a first view of the one or more views has a corresponding camera pose that is different from the one or more original camera poses.

Example 6 provides the method of any one of examples 1-5, where generating the one or more generated images includes rendering, based on the one or more query images, one or more augmented images with one or more artificial light sources added to the one or more query images, where a first artificial light source has a directionality and an intensity.

Example 7 provides the method of any one of examples 1-6, where generating the one or more generated images includes removing a background of at least one or more of the one or more query images.

Example 8 provides the method of any one of examples 1-7, where generating the one or more generated images includes replacing a background of at least one or more of the one or more query images with a different background.

Example 9 provides the method of any one of examples 1-8, where generating the one or more generated images includes enhancing, using a neural network, at least one or more of the one or more query images.

Example 10 provides the method of any one of examples 1-9, where generating the one or more generated images includes determining information about the one or more query images; and generating, using a diffusion model, the one or more generated images conditioned on the information.

Example 11 provides the method of any one of examples 1-10, where generating the one or more generated images includes extracting information about the one or more query images; and selecting, based on the information, the one or more image generators to be used to generate the one or more generated images.

Example 12 provides the method of any one of examples 1-11, where generating the one or more generated images includes extracting information about the one or more query images; and determining, based on the information, a number of images to generate using the one or more image generators.

Example 13 provides the method of any one of examples 1-12, where generating the one or more generated images includes extracting information about the one or more query images; and determining, based on the information, one or more respective numbers of images to generate using the one or more image generators.

Example 14 provides the method of any one of examples 1-13, further including extracting information about the one or more query images; and determining, based on the information, weights that correspond to the one or more first feature vectors and the one or more second feature vectors, where the weights are used by the similarity search engine in the searching of the one or more matching feature vectors.

Example 15 provides the method of any one of examples 1-14, further including extracting information about the one or more query images; and determining, based on the information, weights that correspond to the one or more first feature vectors and the one or more second feature vectors, where the weights are used by the similarity search engine to rank of the one or more matching feature vectors.

Example 16 provides the method of any one of examples 1-15, further including receiving, from the similarity search engine, one or more quality metrics associated with the one or more top matching feature vectors as feedback information to the one or more image generators; and selecting, based on the one or more quality metrics, one or more further image generators to be used in generating one or more further generated images.

Example 17 provides the method of any one of examples 1-16, further including receiving, from the similarity search engine, one or more quality metrics associated with the one or more top matching feature vectors as feedback information to the one or more image generators; generating one or more further generated images in response to the one or more quality metrics not meeting one or more conditions; generating one or more third feature vectors based on the one or more further generated images; searching, by the similarity search engine, for one or more further matching feature vectors to the one or more first feature vectors, the one or more second feature vectors, and the one or more third feature vectors in the library of candidate feature vectors; and outputting, by the similarity search engine, one or more further top matching feature vectors based on the one or more further matching feature vectors.

Example 18 provides the method of any one of examples 1-17, where generating the one or more generated images includes determining one or more captions about the one or more query images; and generating, using a diffusion model, the one or more generated images conditioned on the one or more captions.

Example 19 provides the method of any one of examples 1-18, where searching for the one or more matching feature vectors includes computing similarity metrics, the similarity metrics measuring similarity between (1) each one of the one or more first feature vectors and the one or more second feature vectors, and (2) a first candidate feature vector in the library of candidate feature vectors; and determining the one or more matching feature vectors based on the similarity metrics.

Example 20 provides the method of any one of examples 1-19, where searching for the one or more matching feature vectors includes computing an ensemble similarity metric between: (1) an ensemble of feature vectors having the one or more first feature vectors, and the one or more second feature vectors, and (2) a first candidate feature vector in the library of candidate feature vectors; and determining the one or more matching feature vectors based on the ensemble similarity metric.

Example 21 provides the method of example 20, where computing the ensemble similarity metric includes receiving one or more weights corresponding to one or more of: the one or more of first feature vectors, and the one or more of second feature vectors; and computing a weighted sum of similarity metrics measuring similarity between: (A) each one of the one or more first feature vectors, and the one or more second feature vectors, and (B) a first candidate feature vector in the library of candidate feature vectors, using the one or more weights.

Example 22 provides the method of example 20 or 21, where computing the ensemble similarity metric includes receiving one or more signals corresponding to one or more of: the one or more of first feature vectors, and the one or more of second feature vectors; and computing a combined similarity metric using: (A) similarity metrics measuring similarity between: (i) each one of the one or more first feature vectors and the one or more second feature vectors, and (ii) a first candidate feature vector in the library of candidate feature vectors, (B) a combination function, and (C) the one or more signals.

Example 23 provides the method of any one of examples 1-22, further including selecting, by the similarity search engine, the one or more top matching feature vectors having one or more similarity metrics that meet one or more conditions.

Example 24 provides the method of any one of examples 1-23, further including selecting, by the similarity search engine, the one or more top matching feature vectors having one or more ensemble similarity metrics that meet one or more conditions.

Example 25 provides the method of any one of examples 1-24, further including ranking, by the similarity search engine, the one or more top matching feature vectors based on one or more similarity metrics computed for the one or more top matching feature vectors.

Example 26 provides the method of any one of examples 1-25, further including ranking, by the similarity search engine, the one or more top matching feature vectors based on one or more ensemble similarity metrics computed for the one or more top matching feature vectors.

Example 27 provides the method of any one of examples 1-26, further including receiving one or more weights corresponding to one or more of: the one or more of first feature vectors, and the one or more of second feature vectors; and ranking, by the similarity search engine, the one or more top matching feature vectors based on one or more weights.

Example 28 provides the method of any one of examples 1-27, further including receiving one or more signals corresponding to one or more of: the one or more of first feature vectors, and the one or more of second feature vectors; and ranking, by the similarity search engine, the one or more top matching feature vectors based on one or more signals.

Example 29 provides the method of any one of examples 1-28, further including determining one or more quality metrics associated with the one or more top matching feature vectors as feedback information to the one or more image generators based on whether one or more similarity metrics for the one or more top matching feature vectors meet one or more conditions.

Example 30 provides the method of any one of examples 1-29, further including determining one or more quality metrics associated with the one or more top matching feature vectors as feedback information to the one or more image generators based on whether one or more ensemble similarity metrics for the one or more top matching feature vectors meet one or more conditions.

Example 31 provides an apparatus, including one or more processors for executing instructions; and a non-transitory computer-readable memory storing the instructions, the instructions causing the one or more processors to: generate one or more generated images based on one or more query images; generate one or more first feature vectors based on the one or more query images; generate one or more second feature vectors based on the one or more generated images; search for one or more matching feature vectors to the one or more first feature vectors and the one or more second feature vectors in a library of candidate feature vectors generated from candidate images; and output one or more top matching feature vectors based on the one or more matching feature vectors.

Example 32 provides the apparatus of example 31, where the instructions cause the one or more processors to further: output one or more weights corresponding to the one or more generated images, where the one or more weights are used in the searching of the one or more matching feature vectors.

Example 33 provides the apparatus of example 31 or 32, where the instructions cause the one or more processors to further: output one or more weights corresponding to the one or more generated images, where the one or more weights are used in determining the one or more top matching feature vectors.

Example 34 provides the apparatus of any one of examples 31-33, where the instructions cause the one or more processors to further: output one or more quality metrics associated with the one or more top matching feature vectors.

Example 35 provides the apparatus of any one of examples 31-34, where generating the one or more generated images includes constructing a three-dimensional representation of a scene from the one or more query images corresponding to one or more original camera poses; and generating, based on the three-dimensional representation, one or more views of the scene, where a first view of the one or more views has a corresponding camera pose that is different from the one or more original camera poses.

Example 36 provides the apparatus of any one of examples 31-35, where generating the one or more generated images includes rendering, based on the one or more query images, one or more augmented images with one or more artificial light sources added to the one or more query images, where a first artificial light source has a directionality and an intensity.

Example 37 provides the apparatus of any one of examples 31-36, where generating the one or more generated images includes removing a background of at least one or more of the one or more query images.

Example 38 provides the apparatus of any one of examples 31-37, where generating the one or more generated images includes replacing a background of at least one or more of the one or more query images with a different background.

Example 39 provides the apparatus of any one of examples 31-38, where generating the one or more generated images includes enhancing, using a neural network, at least one or more of the one or more query images.

Example 40 provides the apparatus of any one of examples 31-39, where generating the one or more generated images includes determining information about the one or more query images; and generating, using a diffusion model, the one or more generated images conditioned on the information.

Example 41 provides the apparatus of any one of examples 31-40, where generating the one or more generated images includes extracting information about the one or more query images; and selecting, based on the information, one or more image generators to be used to generate the one or more generated images.

Example 42 provides the apparatus of any one of examples 31-41, where generating the one or more generated images includes extracting information about the one or more query images; and determining, based on the information, a number of the one or more generated images to be generated.

Example 43 provides the apparatus of any one of examples 31-42, where generating the one or more generated images includes extracting information about the one or more query images; and determining, based on the information, one or more respective numbers of images to generate using one or more image generators.

Example 44 provides the apparatus of any one of examples 31-43, where the instructions cause the one or more processors to further: extract information about the one or more query images; and determine, based on the information, weights that correspond to the one or more first feature vectors and the one or more second feature vectors, where the weights are used in the searching of the one or more matching feature vectors.

Example 45 provides the apparatus of any one of examples 31-44, where the instructions cause the one or more processors to further: extract information about the one or more query images; and determine, based on the information, weights that correspond to the one or more first feature vectors and the one or more second feature vectors, where the weights are used to rank of the one or more matching feature vectors.

Example 46 provides the apparatus of any one of examples 31-45, where the instructions cause the one or more processors to further: receive one or more quality metrics associated with the one or more top matching feature vectors as feedback information; and select, based on the one or more quality metrics, one or more image generators to be used in generating one or more further generated images.

Example 47 provides the apparatus of any one of examples 31-46, where the instructions cause the one or more processors to further: receive one or more quality metrics associated with the one or more top matching feature vectors as feedback information; generate one or more further generated images in response to the one or more quality metrics not meeting one or more conditions; generate one or more third feature vectors based on the one or more further generated images; search for one or more further matching feature vectors to the one or more first feature vectors, the one or more second feature vectors, and the one or more third feature vectors in the library of candidate feature vectors; and output one or more further top matching feature vectors based on the one or more further matching feature vectors.

Example 48 provides the apparatus of any one of examples 31-47, where generating the one or more generated images includes determining one or more captions about the one or more query images; and generating, using a diffusion model, the one or more generated images conditioned on the one or more captions.

Example 49 provides the apparatus of any one of examples 31-48, where searching for the one or more matching feature vectors includes computing similarity metrics, the similarity metrics measuring similarity between (1) each one of the one or more first feature vectors and the one or more second feature vectors, and (2) a first candidate feature vector in the library of candidate feature vectors; and determining the one or more matching feature vectors based on the similarity metrics.

Example 50 provides the apparatus of any one of examples 31-49, where searching for the one or more matching feature vectors includes computing an ensemble similarity metric between: (1) an ensemble of feature vectors having the one or more first feature vectors, and the one or more second feature vectors, and (2) a first candidate feature vector in the library of candidate feature vectors; and determining the one or more matching feature vectors based on the ensemble similarity metric.

Example 51 provides the apparatus of example 50, where computing the ensemble similarity metric includes receiving one or more weights corresponding to one or more of: the one or more of first feature vectors, and the one or more of second feature vectors; and computing a weighted sum of similarity metrics measuring similarity between: (A) each one of the one or more first feature vectors, and the one or more second feature vectors, and (B) a first candidate feature vector in the library of candidate feature vectors, using the one or more weights.

Example 52 provides the apparatus of example 50 or 51, where computing the ensemble similarity metric includes receiving one or more signals corresponding to one or more of: the one or more of first feature vectors, and the one or more of second feature vectors; and computing a combined similarity metric using: (A) similarity metrics measuring similarity between: (i) each one of the one or more first feature vectors and the one or more second feature vectors, and (ii) a first candidate feature vector in the library of candidate feature vectors, (B) a combination function, and (C) the one or more signals.

Example 53 provides the apparatus of any one of examples 31-52, where the instructions cause the one or more processors to further: select the one or more top matching feature vectors having one or more similarity metrics that meet one or more conditions.

Example 54 provides the apparatus of any one of examples 31-53, where the instructions cause the one or more processors to further: select the one or more top matching feature vectors having one or more ensemble similarity metrics that meet one or more conditions.

Example 55 provides the apparatus of any one of examples 31-54, where the instructions cause the one or more processors to further: rank the one or more top matching feature vectors based on one or more similarity metrics computed for the one or more top matching feature vectors.

Example 56 provides the apparatus of any one of examples 31-55, where the instructions cause the one or more processors to further: rank the one or more top matching feature vectors based on one or more ensemble similarity metrics computed for the one or more top matching feature vectors.

Example 57 provides the apparatus of any one of examples 31-56, where the instructions cause the one or more processors to further: receive one or more weights corresponding to one or more of: the one or more of first feature vectors, and the one or more of second feature vectors; and rank the one or more top matching feature vectors based on the one or more weights.

Example 58 provides the apparatus of any one of examples 31-57, where the instructions cause the one or more processors to further: receive one or more signals corresponding to one or more of: the one or more of first feature vectors, and the one or more of second feature vectors; and rank the one or more top matching feature vectors based on the one or more signals.

Example 59 provides the apparatus of any one of examples 31-58, where the instructions cause the one or more processors to further: determine one or more quality metrics associated with the one or more top matching feature vectors based on whether one or more similarity metrics for the one or more top matching feature vectors meet one or more conditions.

Example 60 provides the apparatus of any one of examples 31-59, where the instructions cause the one or more processors to further: determine one or more quality metrics associated with the one or more top matching feature vectors based on whether one or more ensemble similarity metrics for the one or more top matching feature vectors meet one or more conditions.

Example 61 provides one or more non-transitory computer-readable media storing instructions that, when executed by one or more processors, cause the one or more processors to: generate one or more generated images based on one or more query images; generate one or more first feature vectors based on the one or more query images; generate one or more second feature vectors based on the one or more generated images; search for one or more matching feature vectors to the one or more first feature vectors and the one or more second feature vectors in a library of candidate feature vectors generated from candidate images; and output one or more top matching feature vectors based on the one or more matching feature vectors.

Example 62 provides the one or more non-transitory computer-readable media of example 61, where the instructions cause the one or more processors to further: output one or more weights corresponding to the one or more generated images, where the one or more weights are used in the searching of the one or more matching feature vectors.

Example 63 provides the one or more non-transitory computer-readable media of example 61 or 62, where the instructions cause the one or more processors to further: output one or more weights corresponding to the one or more generated images, where the one or more weights are used in determining the one or more top matching feature vectors.

Example 64 provides the one or more non-transitory computer-readable media of any one of examples 61-63, where the instructions cause the one or more processors to further: output one or more quality metrics associated with the one or more top matching feature vectors.

Example 65 provides the one or more non-transitory computer-readable media of any one of examples 61-64, where generating the one or more generated images includes constructing a three-dimensional representation of a scene from the one or more query images corresponding to one or more original camera poses; and generating, based on the three-dimensional representation, one or more views of the scene, where a first view of the one or more views has a corresponding camera pose that is different from the one or more original camera poses.

Example 66 provides the one or more non-transitory computer-readable media of any one of examples 61-65, where generating the one or more generated images includes rendering, based on the one or more query images, one or more augmented images with one or more artificial light sources added to the one or more query images, where a first artificial light source has a directionality and an intensity.

Example 67 provides the one or more non-transitory computer-readable media of any one of examples 61-66, where generating the one or more generated images includes removing a background of at least one or more of the one or more query images.

Example 68 provides the one or more non-transitory computer-readable media of any one of examples 61-67, where generating the one or more generated images includes replacing a background of at least one or more of the one or more query images with a different background.

Example 69 provides the one or more non-transitory computer-readable media of any one of examples 61-68, where generating the one or more generated images includes enhancing, using a neural network, at least one or more of the one or more query images.

Example 70 provides the one or more non-transitory computer-readable media of any one of examples 61-69, where generating the one or more generated images includes determining information about the one or more query images; and generating, using a diffusion model, the one or more generated images conditioned on the information.

Example 71 provides the one or more non-transitory computer-readable media of any one of examples 61-70, where generating the one or more generated images includes extracting information about the one or more query images; and selecting, based on the information, one or more image generators to be used to generate the one or more generated images.

Example 72 provides the one or more non-transitory computer-readable media of any one of examples 61-71, where generating the one or more generated images includes extracting information about the one or more query images; and determining, based on the information, a number of the one or more generated images to be generated.

Example 73 provides the one or more non-transitory computer-readable media of any one of examples 61-72, where generating the one or more generated images includes extracting information about the one or more query images; and determining, based on the information, one or more respective numbers of images to generate using one or more image generators.

Example 74 provides the one or more non-transitory computer-readable media of any one of examples 61-73, where the instructions cause the one or more processors to further: extract information about the one or more query images; and determine, based on the information, weights that correspond to the one or more first feature vectors and the one or more second feature vectors, where the weights are used in the searching of the one or more matching feature vectors.

Example 75 provides the one or more non-transitory computer-readable media of any one of examples 61-74, where the instructions cause the one or more processors to further: extract information about the one or more query images; and determine, based on the information, weights that correspond to the one or more first feature vectors and the one or more second feature vectors, where the weights are used to rank of the one or more matching feature vectors.

Example 76 provides the one or more non-transitory computer-readable media of any one of examples 61-75, where the instructions cause the one or more processors to further: receive one or more quality metrics associated with the one or more top matching feature vectors as feedback information; and select, based on the one or more quality metrics, one or more image generators to be used in generating one or more further generated images.

Example 77 provides the one or more non-transitory computer-readable media of any one of examples 61-76, where the instructions cause the one or more processors to further: receive one or more quality metrics associated with the one or more top matching feature vectors as feedback information; generate one or more further generated images in response to the one or more quality metrics not meeting one or more conditions; generate one or more third feature vectors based on the one or more further generated images; search for one or more further matching feature vectors to the one or more first feature vectors, the one or more second feature vectors, and the one or more third feature vectors in the library of candidate feature vectors; and output one or more further top matching feature vectors based on the one or more further matching feature vectors.

Example 78 provides the one or more non-transitory computer-readable media of any one of examples 61-77, where generating the one or more generated images includes determining one or more captions about the one or more query images; and generating, using a diffusion model, the one or more generated images conditioned on the one or more captions.

Example 79 provides the one or more non-transitory computer-readable media of any one of examples 61-78, where searching for the one or more matching feature vectors includes computing similarity metrics, the similarity metrics measuring similarity between (1) each one of the one or more first feature vectors and the one or more second feature vectors, and (2) a first candidate feature vector in the library of candidate feature vectors; and determining the one or more matching feature vectors based on the similarity metrics.

Example 80 provides the one or more non-transitory computer-readable media of any one of examples 61-79, where searching for the one or more matching feature vectors includes computing an ensemble similarity metric between: (1) an ensemble of feature vectors having the one or more first feature vectors, and the one or more second feature vectors, and (2) a first candidate feature vector in the library of candidate feature vectors; and determining the one or more matching feature vectors based on the ensemble similarity metric.

Example 81 provides the one or more non-transitory computer-readable media of example 80, where computing the ensemble similarity metric includes receiving one or more weights corresponding to one or more of: the one or more of first feature vectors, and the one or more of second feature vectors; and computing a weighted sum of similarity metrics measuring similarity between: (A) each one of the one or more first feature vectors, and the one or more second feature vectors, and (B) a first candidate feature vector in the library of candidate feature vectors, using the one or more weights.

Example 82 provides the one or more non-transitory computer-readable media of example 80 or 81, where computing the ensemble similarity metric includes receiving one or more signals corresponding to one or more of: the one or more of first feature vectors, and the one or more of second feature vectors; and computing a combined similarity metric using: (A) similarity metrics measuring similarity between: (i) each one of the one or more first feature vectors and the one or more second feature vectors, and (ii) a first candidate feature vector in the library of candidate feature vectors, (B) a combination function, and (C) the one or more signals.

Example 83 provides the one or more non-transitory computer-readable media of any one of examples 61-82, where the instructions cause the one or more processors to further: select the one or more top matching feature vectors having one or more similarity metrics that meet one or more conditions.

Example 84 provides the one or more non-transitory computer-readable media of any one of examples 61-83, where the instructions cause the one or more processors to further: select the one or more top matching feature vectors having one or more ensemble similarity metrics that meet one or more conditions.

Example 85 provides the one or more non-transitory computer-readable media of any one of examples 61-84, where the instructions cause the one or more processors to further: rank the one or more top matching feature vectors based on one or more similarity metrics computed for the one or more top matching feature vectors.

Example 86 provides the one or more non-transitory computer-readable media of any one of examples 61-85, where the instructions cause the one or more processors to further: rank the one or more top matching feature vectors based on one or more ensemble similarity metrics computed for the one or more top matching feature vectors.

Example 87 provides the one or more non-transitory computer-readable media of any one of examples 61-86, where the instructions cause the one or more processors to further: receive one or more weights corresponding to one or more of: the one or more of first feature vectors, and the one or more of second feature vectors; and rank the one or more top matching feature vectors based on the one or more weights.

Example 88 provides the one or more non-transitory computer-readable media of any one of examples 61-87, where the instructions cause the one or more processors to further: receive one or more signals corresponding to one or more of: the one or more of first feature vectors, and the one or more of second feature vectors; and rank the one or more top matching feature vectors based on the one or more signals.

Example 89 provides the one or more non-transitory computer-readable media of any one of examples 61-88, where the instructions cause the one or more processors to further: determine one or more quality metrics associated with the one or more top matching feature vectors based on whether one or more similarity metrics for the one or more top matching feature vectors meet one or more conditions.

Example 90 provides the one or more non-transitory computer-readable media of any one of examples 61-89, where the instructions cause the one or more processors to further: determine one or more quality metrics associated with the one or more top matching feature vectors based on whether one or more ensemble similarity metrics for the one or more top matching feature vectors meet one or more conditions.

Example A provides an apparatus comprising means for carrying out any one of the methods in examples 1-30.

Example B provides a system comprising one or more image generators and a similarity search engine as described herein.

### Variations and Other Notes

The various implementations described herein may refer to artificial intelligence, machine learning, and deep learning. Deep learning may be a subset of machine learning. Machine learning may be a subset of artificial intelligence. In cases where a deep learning model is mentioned, if suitable for a particular application, a machine learning model may be used instead. In cases where a deep learning model is mentioned, if suitable for a particular application, a digital signal processing system may be used instead.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. A method, comprising:
generating, by one or more image generators, one or more generated images based on one or more query images;
generating one or more first feature vectors based on the one or more query images;
generating one or more second feature vectors based on the one or more generated images;
searching, by a similarity search engine, for one or more matching feature vectors to the one or more first feature vectors and the one or more second feature vectors in a library of candidate feature vectors generated from candidate images; and
outputting, by the similarity search engine, one or more top matching feature vectors based on the one or more matching feature vectors.

2. The method of claim 1, wherein generating the one or more generated images comprises:
constructing a three-dimensional representation of a scene from the one or more query images corresponding to one or more original camera poses; and
generating, based on the three-dimensional representation, one or more views of the scene, wherein a first view of the one or more views has a corresponding camera pose that is different from the one or more original camera poses.

3. The method of claim 1, wherein generating the one or more generated images comprises:
rendering, based on the one or more query images, one or more augmented images with one or more artificial light sources added to the one or more query images, wherein a first artificial light source has a directionality and an intensity.

4. The method of claim 1, wherein generating the one or more generated images comprises:
enhancing, using a neural network, at least one or more of the one or more query images.

5. The method of claim 1, wherein generating the one or more generated images comprises:
determining information about the one or more query images; and
generating, using a diffusion model, the one or more generated images conditioned on the information.

6. The method of claim 1, wherein generating the one or more generated images comprises:
determining one or more captions about the one or more query images; and
generating, using a diffusion model, the one or more generated images conditioned on the one or more captions.

7. The method of claim 1, wherein searching for the one or more matching feature vectors comprises:
computing similarity metrics, the similarity metrics measuring similarity between (1) each one of the one or more first feature vectors and the one or more second feature vectors, and (2) a first candidate feature vector in the library of candidate feature vectors; and
determining the one or more matching feature vectors based on the similarity metrics.

8. The method of claim 1, wherein searching for the one or more matching feature vectors comprises:
computing an ensemble similarity metric between:
(1) an ensemble of feature vectors having the one or more first feature vectors, and the one or more second feature vectors, and
(2) a first candidate feature vector in the library of candidate feature vectors; and
determining the one or more matching feature vectors based on the ensemble similarity metric.

9. The method of claim 8, wherein computing the ensemble similarity metric comprises:
receiving one or more weights corresponding to one or more of: the one or more of first feature vectors, and the one or more of second feature vectors; and
computing a weighted sum of similarity metrics measuring similarity between:
(A) each one of the one or more first feature vectors, and the one or more second feature vectors, and
(B) a first candidate feature vector in the library of candidate feature vectors, using the one or more weights.

10. The method of claim 8, wherein computing the ensemble similarity metric comprises:
receiving one or more signals corresponding to one or more of: the one or more of first feature vectors, and the one or more of second feature vectors; and
computing a combined similarity metric using:
(A) similarity metrics measuring similarity between:
(i) each one of the one or more first feature vectors and the one or more second feature vectors, and
(ii) a first candidate feature vector in the library of candidate feature vectors,
(B) a combination function, and
(C) the one or more signals.

11. The method of claim 1, further comprising:
receiving one or more weights corresponding to one or more of: the one or more of first feature vectors, and the one or more of second feature vectors; and
ranking, by the similarity search engine, the one or more top matching feature vectors based on one or more weights.

12. The method of claim 1, further comprising:
determining one or more quality metrics associated with the one or more top matching feature vectors as feedback information to the one or more image generators based on whether one or more similarity metrics for the one or more top matching feature vectors meet one or more conditions.

13. An apparatus, comprising:
one or more processors for executing instructions; and
a non-transitory computer-readable memory storing the instructions, the instructions causing the one or more processors to:
generate one or more generated images based on one or more query images;
generate one or more first feature vectors based on the one or more query images;
generate one or more second feature vectors based on the one or more generated images;
search for one or more matching feature vectors to the one or more first feature vectors and the one or more second feature vectors in a library of candidate feature vectors generated from candidate images; and
output one or more top matching feature vectors based on the one or more matching feature vectors.

14. The apparatus of claim 13, wherein generating the one or more generated images comprises:
removing a background of at least one or more of the one or more query images.

15. The apparatus of claim 13, wherein generating the one or more generated images comprises:
replacing a background of at least one or more of the one or more query images with a different background.

16. The apparatus of claim 13, wherein generating the one or more generated images comprises:
extracting information about the one or more query images; and
selecting, based on the information, one or more image generators to be used to generate the one or more generated images.

17. The apparatus of claim 13, wherein generating the one or more generated images comprises:
extracting information about the one or more query images; and
determining, based on the information, a number of the one or more generated images to be generated.

18. One or more non-transitory computer-readable media storing instructions that, when executed by one or more processors, cause the one or more processors to:
generate one or more generated images based on one or more query images;
generate one or more first feature vectors based on the one or more query images;
generate one or more second feature vectors based on the one or more generated images;
search for one or more matching feature vectors to the one or more first feature vectors and the one or more second feature vectors in a library of candidate feature vectors generated from candidate images; and
output one or more top matching feature vectors based on the one or more matching feature vectors.

19. The one or more non-transitory computer-readable media of claim 18, wherein the instructions cause the one or more processors to further:
output one or more weights corresponding to the one or more generated images, wherein the one or more weights are used in determining the one or more top matching feature vectors.

20. The one or more non-transitory computer-readable media of claim 18, wherein the instructions cause the one or more processors to further:
output one or more quality metrics associated with the one or more top matching feature vectors.
